(19) United States
(12) Patent Application Publication
(10) Pub. No.: US 2023/0295397 A1
(43) Pub. Date: Sep. 21, 2023

(54) RESIN COMPOSITION RECYCLER

(71) Applicant: HONDA MOTOR CO., LTD., Tokyo (JP)

(72) Inventors: Shoko HIRAOKA, Saitama (JP); Satoshi HIRAWAKI, Saitama (JP); Tsuyoshi BABA, Saitama (JP); Masatoshi KOBAYASHI, Saitama (JP)

(21) Appl. No.: 18/171,295

(22) Filed: Feb. 17, 2023

(30) Foreign Application Priority Data
Mar. 18, 2022 (JP) 2022-044180

(51) Int. Cl. C08J 11/14

(52) U.S. Cl. CPC C08J 11/14; C08J 2377/02; C08J 2367/02

(57) ABSTRACT

Provided is a resin composition recycler for recycling a resin composition including a resin and an additive. The resin composition recycler includes: an extrusion reactor that hydrolyzes the resin included in the resin composition to obtain a depolymerized product; and a vaporizer that thermally decomposes the depolymerized product to vaporize a monomer, and the extrusion reactor comprises: a first introducer that introduces the resin composition; a second introducer that introduces water; and a screw that mixes the resin composition with the water.

This application is based on and claims the benefit of priority from Japanese Patent Application No. 2022-044180, filed on 18 Mar. 2022, the content of which is incorporated herein by reference.

### BACKGROUND OF THE INVENTION

### Field of the Invention

The present invention relates to a resin composition recycler.

### Related Art

Conventionally, a ring-opening polymer of ε-caprolactam (for example, polyamide 6) is mixed with an additive so as to be used, and methods for recycling waste are being studied.

Japanese Unexamined Patent Application (Translation of PCT Application), Publication No. H10-510280 discloses a method for recycling waste. Specifically, an extruder is first used to melt a ring-opening polymer of ε-caprolactam by application of heat, and compress the ring-opening polymer of ε-caprolactam. Thereafter, a pressure-resistant tubular reactor is used to hydrolyze the ring-opening polymer of ε-caprolactam by superheated steam, thereby generating ε-caprolactam. Then, a depression device is used to remove water, and a filter device is thereafter used to remove an additive. Finally, a liquid which has passed through the filter device is purified, and thus ε-caprolactam is recovered.

Patent Document 1: Japanese Unexamined Patent Application (Translation of PCT Application), Publication No. H10-510280

### SUMMARY OF THE INVENTION

However, even when the ring-opening polymer of ε-caprolactam is hydrolyzed, the ring-opening polymer is left as an undegraded oligomer, and thus the oligomer is removed with the filter device. Hence, it is desired to enhance the recovery rate of ε-caprolactam.

An object of the present invention is to provide a resin composition recycler which can enhance the recovery rate of the monomer constituting a resin included in a resin composition.

An aspect of the present invention is directed to a resin composition recycler for recycling a resin composition including a resin and an additive. The resin composition recycler includes: an extrusion reactor that hydrolyzes the resin included in the resin composition to obtain a depolymerized product; and a vaporizer that thermally decomposes the depolymerized product to vaporize a monomer, and the extrusion reactor includes: a first introducer that introduces the resin composition; a second introducer that introduces water; and a screw that mixes the resin composition with the water.

The extrusion reactor and the vaporizer may be coupled via a back-pressure valve.

The vaporizer and the back-pressure valve may be coupled via a gas-liquid separator that separates a monomer from the depolymerized product.

The resin composition recycler described above may further includes: a condenser that condenses the monomer vaporized by the vaporizer and the monomer separated by the gas-liquid separator.

The resin composition recycler may further include: a depressurizer that depressurizes the interior of the vaporizer.

The vaporizer may include a conveyor that conveys the depolymerized product.

The conveyor may be a screw conveyor.

The resin composition may be a fiber-reinforced resin.

According to the present invention, it is possible to provide a resin composition recycler which can enhance the recovery rate of the monomer constituting a resin included in a resin composition.

### BRIEF DESCRIPTION OF THE DRAWINGS

FIG. 1 is a schematic view showing an example of a resin composition recycler according to an embodiment; and

FIG. 2 is a schematic view showing a variation of the resin composition recycler shown in FIG. 1.

### DETAILED DESCRIPTION OF THE INVENTION

An embodiment of the present invention will be described below with reference to the drawings.

A resin composition recycler according to the present embodiment is a device which recycles a resin composition including a resin and an additive. Although the resin is not particularly limited as long as the resin can be hydrolyzed to be depolymerized, examples of the resin include polyamides (for example, polyamide 6 and polyamide 66), polyesters (for example, polyethylene terephthalate (PET) and polybutylene terephthalate (PBT)), polycarbonate (PC) and the like. Here, a single monomer or a plurality of monomers may constitute the resin. When a plurality of monomers constitute the resin, at least a part of the monomers constituting the resin are recovered. Although the additive is not particularly limited, examples of the additive include: inorganic fibers such as a glass fiber and a carbon fiber; organic fibers such as an aramid fiber and a cellulosic fiber; talc; mica; aluminum flakes; and the like, and two or more types thereof may be used together. The resin composition recycler in the present embodiment is particularly effective when a fiber-reinforced resin is recycled.

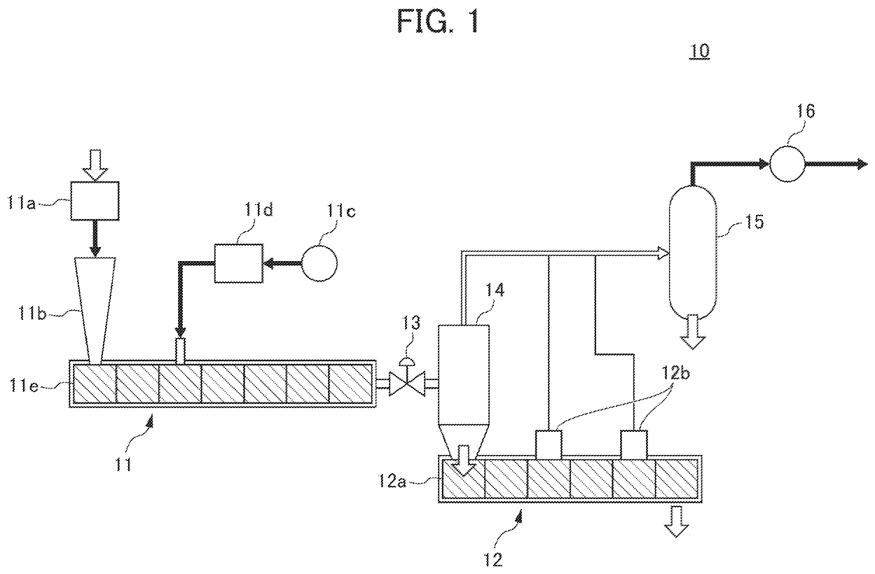

FIG. 1 shows an example of the resin composition recycler in the present embodiment.

The resin composition recycler 10 includes: an extrusion reactor 11 which hydrolyzes the resin included in the resin composition to obtain a depolymerized product; and a vaporizer 12 that thermally decomposes the depolymerized product to vaporize the monomer. Here, the extrusion reactor 11 includes: a raw material feeder 11a and a raw material hopper 11b which serve as a first introducer for introducing the resin composition; a high-pressure water pump 11c and a water heater 11d which serve as a second introducer for introducing water; and a screw which crushes the resin composition and mixes the crushed resin composition with the water. The depolymerized product includes the monomer, an oligomer and the like. Here, since the vaporizer 12 thermally decomposes the depolymerized product to vaporize the monomer, the recovery rate of the monomer is enhanced. Since the resin included in the resin composition is hydrolyzed by the extrusion reactor 11, a hydrolysis reaction is accelerated.

As the extrusion reactor 11, for example, a twin screw extruder can be used. Each of cylinder blocks 11e in the extrusion reactor 11 can be heated by a heater and cooled by cooling water, chiller water or the like. The raw material feeder 11a quantitatively supplies, into the raw material hopper 11b, for example, the crushed resin composition which has been wasted. Furthermore, the raw material hopper 11b feeds the crushed resin composition into the extrusion reactor 11. On the other hand, the high-pressure water pump 11c supplies water into the extrusion reactor 11 from a predetermined cylinder block 11e. Here, since water can be quantitatively supplied even when the pressure of the interior of the extrusion reactor 11 is increased, a diaphragm or a plunger pump is used as the high-pressure water pump 11c. In the water heater 11d, for example, a water pipe is processed into a spiral shape and is installed in a tubular furnace partway through a high-pressure water pipe, and thus the water pipe is heated. Instead of the water heater 11d, a high-temperature heat medium oil may be used to heat water by a heat exchanger.

The extrusion reactor 11 and the vaporizer 12 are coupled via a back-pressure valve (pressure control valve) 13. In this way, the pressure of the interior of the extrusion reactor 11 is held, and thus the hydrolysis (depolymerization) of the resin included in the resin composition is accelerated.

The vaporizer 12 and the back-pressure valve 13 are coupled via a gas-liquid separator 14 which separates a monomer from the depolymerized product. Hence, the configuration of the vaporizer 12 can be simplified, and the monomer with high purity is recovered. The gas-liquid separator 14 is a tank which performs flash distillation on a reaction liquid under high pressure, and a gas component is discharged from the upper side and liquid and solid components are discharged from the lower side. Here, examples of the gas component include the monomer, water and the like. Examples of the liquid component include the oligomer and the like. Examples of the solid component include a fiber and the like.

The vaporizer 12 thermally decomposes the depolymerized product (such as the oligomer) discharged from the lower side of the gas-liquid separator 14 to vaporize the monomer. As the vaporizer 12, for example, a twin screw extruder can be used. Each of cylinder blocks 12a in the vaporizer 12 can be heated by a heater and cooled by cooling water, chiller water or the like. Here, vents 12b are provided in predetermined cylinder blocks 12a of the vaporizer 12, and a gas component which has been vaporized is discharged therefrom. Here, examples of the gas component include the monomer, water vapor, carbon dioxide and the like. In the most downstream cylinder block 12a of the vaporizer 12, a discharge port is provided, and thus liquid and solid components which are left without being vaporized are discharged.

The vaporizer 12 includes a conveyor which conveys the depolymerized product, and thus the depolymerized product is thermally decomposed in a continuous manner. Since a screw conveyor is used as the conveyor, the depolymerized product is uniformly heated, and moreover, the depolymerized product adhered to a fiber is separated from the fiber.

The vaporizer 12 may be heated with a constant-temperature chamber.

The resin composition recycler 10 further includes a condenser 15 which condenses the monomer vaporized by the vaporizer 12 and the monomer separated by the gas-liquid separator 14. In this way, the condenser which condenses the monomer vaporized by the vaporizer 12 and the monomer separated by the gas-liquid separator 14 can be shared, and thus the configuration of the resin composition recycler 10 can be simplified and the size thereof can be reduced. In the condenser 15, the gas component is cooled, trace amounts of water vapor, air and the like are discharged from the upper side and the monomer, water and the like are discharged from the lower side.

The resin composition recycler 10 further includes a depressurizer 16 which depressurizes the interior of the vaporizer 12 and the interior of the gas-liquid separator 14. In this way, the monomer is smoothly vaporized in the vaporizer 12 and the gas-liquid separator 14, and thus the monomer is easily separated and recovered. As compared with a case where the monomer is vaporized in the atmosphere, the oxidation reaction of the monomer is reduced. The depressurizer 16 is, for example, a vacuum pump, and discharges the gas within the vaporizer 12 and the gas within the gas-liquid separator 14 to achieve a negative pressure. Since here, the gas includes water vapor, a water-sealed pump is used as the vacuum pump.

A method for recycling a fiber-reinforced resin with the resin composition recycler 10 will then be described. Here, as an example, a case where the fiber and the resin constituting the fiber-reinforced resin are respectively a glass fiber and polyamide 6 will be described.

The crushed fiber-reinforced resin which is quantitatively supplied from the raw material feeder 11a is fed into the extrusion reactor 11 via the raw material hopper 11b. On the other hand, water heated by the water heater 11d is supplied into the extrusion reactor 11 by the high-pressure water pump 11c. Although here, the mass ratio of the water to the fiber-reinforced resin is not particularly limited, the mass ratio is, for example, equal to or greater than 2 and equal to or less than 10. The temperature of the water is lower than the saturation temperature of the water which is calculated from the internal pressure of the extrusion reactor 11.

The polyamide 6 included in the fiber-reinforced resin fed into the extrusion reactor 11 is thermally melted in the cylinder blocks 11e to which the water for the extrusion reactor 11 has not been supplied. Here, since the cylinder blocks 11e to which the water for the extrusion reactor 11 has not been supplied are sealed with the thermally melted polyamide 6, the viscosity of the thermally melted polyamide 6 needs to be held high. Hence, the temperature of the cylinder blocks 11e until the supply of the water after the crushed fiber-reinforced resin is fed into the extrusion reactor 11 is set to a temperature which is lower than the melting point of the polyamide 6 by about 10° C. or more and 20° C. or less.

In the cylinder blocks 11e after the supply of the water into the extrusion reactor 11, the polyamide 6 is hydrolyzed. Here, the reaction temperature of the hydrolysis reaction of the polyamide 6 is equal to or greater than 320° C. and equal to or less than 360° C., and as the reaction temperature is increased, the reaction time is reduced. Here, the pressure of the interior of the extrusion reactor 11 is controlled to be a pressure which is higher than the steam saturation pressure of the water at the temperature of the interior of the extrusion reactor 11 by about 0.5 MPa or more and 1 MPa or less. The steam saturation pressure of the water at 320° C. is 11.3 MPa, and the steam saturation pressure of the water at 360° C. is 18.7 MPa.

A time during which the fiber-reinforced resin stays in the cylinder blocks 11e after the supply of the water into the extrusion reactor 11 is the reaction time. Since the reaction time is determined by the amount of fiber-reinforced resin supplied, the densities of the polyamide 6 and the water at the time of the hydrolysis reaction and the volume of the interior of the extrusion reactor 11, it is necessary to set the amount of fiber-reinforced resin supplied for the specifications of the extrusion reactor 11. The reaction time which is needed for almost all of the polyamide 6 to be hydrolyzed is about 40 minutes at 320° C., and is about 15 minutes at 360° C.

When the reaction liquid under high pressure is released from the back-pressure valve 13 into the gas-liquid separator 14 under reduced pressure, the gas component is discharged from the upper side and the liquid and solid components are discharged from the lower side by flash distillation. Here, examples of the gas component include ε-caprolactam, water and the like. Examples of the liquid component include an oligomer which is derived from the polyamide 6 and in which its molecular weight is reduced to 2000 or less and the like. Examples of the solid component include a glass fiber and the like.

The gas component discharged from the upper side of the gas-liquid separator 14 is condensed by the condenser 15, and is recovered as a caprolactam aqueous solution.

On the other hand, the liquid and solid components discharged from the lower side of the gas-liquid separator 14 are heated within the vaporizer 12 to a temperature equal to or greater than 400° C. and equal to or less than 450° C., and thus the oligomer is thermally decomposed, with the result that gas components such as ε-caprolactam, water and carbon dioxide are generated. The gas components generated are condensed by the condenser 15 and are recovered as a caprolactam aqueous solution. On the other hand, the liquid and solid components which are left without being vaporized within the vaporizer 12 are discharged from the discharge port of the vaporizer 12.

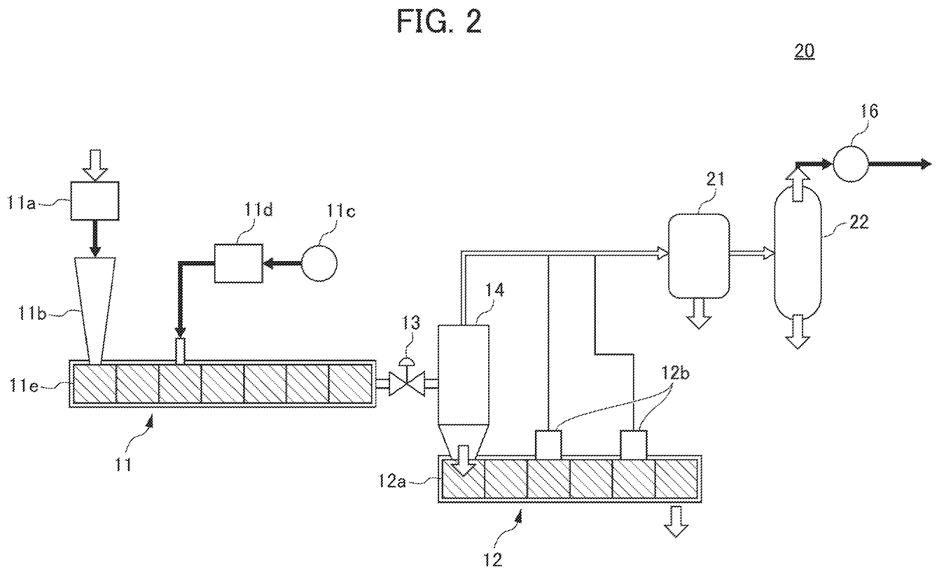

FIG. 2 shows a variation of the resin composition recycler 10.

A resin composition recycler 20 has the same configuration as the resin composition recycler 10 except that a gas-liquid separator 21 and a distiller 22 are provided instead of the condenser 15.

A description will then be given of a method for recycling, with the resin composition recycler 20, a fiber-reinforced resin which includes a resin constituted by a plurality of monomers. Here, as an example, a case where the fiber and the resin constituting the fiber-reinforced resin are respectively a glass fiber and PET will be described.

The crushed fiber-reinforced resin which is quantitatively supplied from the raw material feeder 1a is fed into the extrusion reactor 11 via the raw material hopper 11b. On the other hand, water heated by the water heater 11d is supplied into the extrusion reactor 11 by the high-pressure water pump 11c. Although here, the mass ratio of the water to the fiber-reinforced resin is not particularly limited, the mass ratio is, for example, equal to or greater than 9 and equal to or less than 10. The temperature of the water is lower than the saturation temperature of the water which is calculated from the internal pressure of the extrusion reactor 11.

The PET included in the fiber-reinforced resin fed into the extrusion reactor 11 is thermally melted in the cylinder blocks 11e to which the water for the extrusion reactor 11 has not been supplied. Here, since the cylinder blocks 11e until the supply of the water after the crushed fiber-reinforced resin is fed into the extrusion reactor 11 are sealed with the thermally melted PET, the viscosity of the thermally melted PET needs to be held high. Hence, the temperature of the cylinder blocks 11e to which the water has not been supplied is set to a temperature which is lower than the melting point of the PET by about 10° C. or more and 20° C. or less.

In the cylinder blocks 11e after the supply of the water into the extrusion reactor 11, the PET is hydrolyzed. Here, the reaction temperature of the hydrolysis reaction of the PET is equal to or greater than 250° C. and equal to or less than 300° C., and as the reaction temperature is increased, the reaction time is reduced. Here, the pressure of the interior of the extrusion reactor 11 is controlled to be a pressure which is higher than the steam saturation pressure of the water at the temperature of the interior of the extrusion reactor 11 by about 0.5 MPa or more and 1 MPa or less. The steam saturation pressure of the water at 250° C. is 8.6 MPa, and the steam saturation pressure of the water at 300° C. is 16.5 MPa.

A time during which the fiber-reinforced resin stays in the cylinder blocks 11e after the supply of the water into the extrusion reactor 11 is the reaction time. Since the reaction time is determined by the amount of fiber-reinforced resin supplied, the densities of the PET and the water at the time of the hydrolysis reaction and the volume of the interior of the extrusion reactor 11, it is necessary to set the amount of fiber-reinforced resin supplied for the specifications of the extrusion reactor 11. The reaction time which is needed for almost all of the PET to be hydrolyzed is about 60 minutes at 250° C., and is about 10 minutes at 300° C.

When the reaction liquid under high pressure is released from the back-pressure valve 13 into the gas-liquid separator 14 under reduced pressure, the gas component is discharged from the upper side and the liquid and solid components are discharged from the lower side by flash distillation. Here, examples of the gas component include terephthalic acid, ethylene glycol, water and the like. Examples of the liquid component include an oligomer which is derived from the PET and in which its molecular weight is reduced to 2000 or less and the like. Examples of the solid component include a glass fiber and the like.

Among the gas components discharged from the upper side of the gas-liquid separator 14, the terephthalic acid having a high melting point is solidified within the gas-liquid separator 21 and is recovered from the lower side of the gas-liquid separator 21. On the other hand, the gas component which is not solidified within the gas-liquid separator 21 is discharged from the right side of the gas-liquid separator 21 and is thereafter distilled by the distiller 22. Consequently, among the gas components, the ethylene glycol having a high boiling point is condensed within the distiller 22 and is recovered from the lower side of the distiller 22. On the other hand, the gas component which is not condensed within the distiller 22 is discharged from the upper side of the distiller 22.

On the other hand, the liquid and solid components discharged from the lower side of the gas-liquid separator 14 are heated within the vaporizer 12 to a temperature of about 400° C., and thus the oligomer is thermally decomposed, with the result that gas components such as terephthalic acid, ethylene glycol, water and carbon dioxide are generated. Among the gas components generated, the terephthalic acid having a high melting point is solidified within the gas-liquid separator 21 and is recovered from the lower side of the gas-liquid separator 21. On the other hand, the gas component which is not solidified within the gas-liquid separator 21 is discharged from the right side of the gas-liquid separator 21 and is thereafter distilled by the distiller 22. Consequently, among the gas components, the ethylene glycol having a high boiling point is condensed within the distiller 22 and is recovered from the lower side of the distiller 22. On the other hand, the gas component which is not condensed within the distiller 22 is discharged from the upper side of the distiller 22.

On the other hand, the liquid and solid components which are left without being vaporized within the vaporizer 12 are discharged from the discharge port of the vaporizer 12.

Although the embodiment of the present invention has been described above, the present invention is not limited to the embodiment described above, and the embodiment described above may be changed as necessary without departing from the spirit of the present invention.

### EXPLANATION OF REFERENCE NUMERALS

10, 20: resin composition recycler
11: extrusion reactor
11a: raw material feeder
11b: raw material hopper
11c: high-pressure water pump
11d: water heater
11e: cylinder block
12: vaporizer
12a: cylinder block
12b: vent
13: back-pressure valve
14: gas-liquid separator
15: condenser
21: gas-liquid separator
22: distiller

What is claimed is:

1. A resin composition recycler for recycling a resin composition including a resin and an additive, the resin composition recycler comprising:
an extrusion reactor that hydrolyzes the resin included in the resin composition to obtain a depolymerized product; and
a vaporizer that thermally decomposes the depolymerized product to vaporize a monomer,
wherein the extrusion reactor comprises: a first introducer that introduces the resin composition; a second introducer that introduces water; and a screw that mixes the resin composition with the water.

2. The resin composition recycler according to claim 1, wherein the extrusion reactor and the vaporizer are coupled via a back-pressure valve.

3. The resin composition recycler according to claim 2, wherein the vaporizer and the back-pressure valve are coupled via a gas-liquid separator that separates a monomer from the depolymerized product.

4. The resin composition recycler according to claim 3, further comprising: a condenser that condenses the monomer vaporized by the vaporizer and the monomer separated by the gas-liquid separator.

5. The resin composition recycler according to claim 1, further comprising: a depressurizer that depressurizes an interior of the vaporizer.

6. The resin composition recycler according to claim 1, wherein the vaporizer comprises a conveyor that conveys the depolymerized product.

7. The resin composition recycler according to claim 6, wherein the conveyor is a screw conveyor.

8. The resin composition recycler according to claim 1, wherein the resin composition is a fiber-reinforced resin.
